(19) United States
(12) Patent Application Publication
(10) Pub. No.: US 2011/0189548 A1
(43) Pub. Date: Aug. 4, 2011

(54) IONIC ADDITIVES FOR ELECTROCHEMICAL DEVICES USING INTERCALATION ELECTRODES

(75) Inventor: Kang Conrad Xu, North Potomac, MD (US)

(73) Assignee: US Government as represented by Secretary of ARMY, Adelphi, MD (US)

(21) Appl. No.: 12/699,182

(22) Filed: Feb. 3, 2010

(51) Int. Cl. H01M 6/16; H01M 6/00; H01M 6/04

(52) U.S. Cl. 429/332; 429/188; 429/207; 429/199

(57) ABSTRACT

An electrochemical cell comprising a cathode comprising an electrode active material that reversibly intercalates and de-intercalates any of cations and molecules; an anode comprising an electrode active material that reversibly intercalates and de-intercalates any of cations, anions, and molecules; a separator material that separates the cathode from the anode; and an electrolyte comprising a base electrolyte composition, an ionic compound additive, and a solvent comprising any of aqueous and non-aqueous electrolyte solvents, wherein the additive dissolves in the base electrolyte composition as well a majority of the aqueous or non-aqueous electrolyte solvents, wherein the additive comprises a solubility of at least approximately 0.01 in the base electrolyte composition, wherein the additive dissociates into corresponding cations and anions upon dissolution, and wherein the cations originate from a metal element and reduce to an elemental form at a potential that is at least approximately 0.50 V above that of lithium.

### GOVERNMENT INTEREST

The embodiments described herein may be manufactured, used, and/or licensed by or for the United States Government without the payment of royalties thereon.

### BACKGROUND

1. Technical Field

The embodiments herein generally relate to electrochemistry, and, more particularly, to ionic additives to be used in non-aqueous electrolytes that support the operation of electrochemical devices using intercalation electrodes.

2. Description of the Related Art

The electrochemical devices that utilize intercalation-type electrodes present superior cycle life due to their highly reversible nature, wherein the lattice of intercalation electrode acts as host to accommodate the guest species and hence maintain an almost constant structure during the entire chemistry. Therefore, these new intercalation chemistries have dominated the rechargeable battery chemistries in the past decades. The most prominent example of electrochemical devices based on intercalation electrodes is the lithium (Li) ion battery, in which both cathode and anode are intercalation hosts for Li ion dissolved in non-aqueous solvents. During the operation, Li ions intercalate into or de-intercalate from the interstitial voids of those electrodes, creating a significant potential gap for the electrons to perform the work. Meanwhile, the lattice structures of those intercalation electrodes remains relatively unchanged during the operation, unlike the other non-intercalation electrodes such as alloy-type, conversion-reaction-type or dissolution/deposition-type, rendering up to thousands of charge/discharge cycles to Li ion batteries without obvious performance fade.

However, due to the extreme potentials involved in these intercalation chemistries, the electrolyte components almost always decompose upon the initial charge and form electron-insulating layers between both electrolyte/cathode interface and electrolyte/anode interface. These ad hoc interface layers thus formed, often referred to as solid electrolyte interphase (SEI), serve as both a protection that prevents further consumption of limited resource Li ion due to electrolyte decomposition, and an energy barrier that resists the migration of Li ions into or from the intercalation sites. The latter barrier effect becomes increasingly apparent when the Li ion devices are subjected to very low temperatures or very high charge/discharge rates, resulting in inferior performance and sometimes safety hazard. It is therefore of great interest to the battery industry to find an approach that could minimize the resistances that hinders the movement of Li ion during charge and discharge.

Numerous studies have established that one of the main impedance to Li ion movement comes from the breaking up of Li ion salvation sheath at the electrolyte/electrode interface; e.g., Abe, T., et al., “Solvated Li-lon Transfer at Interface between Graphite and Electrolyte,” J. Electrochem. Soc., Vol. 151, Issue 8, pp. A1120-A1123, Jun. 17, 2004, the complete disclosure of which, in its entirety, is herein incorporated by reference. When Li salt is dissolved in non-aqueous solvents, the naked Li ion is coordinated by up to four polar organic solvent molecules, which forms a tightly-bound sheath. Since the intercalation electrodes can only allow a naked Li ion to be intercalated, the above solvation sheath has to be broken up before Li ion enters the electrode bulk. Due to the small radius of Li ion (which is the smallest among all metal ions), the solvation energy of Li ion by organic polar molecules ranges between 50˜100 kJ/mol, and the process to strip the solvation sheath of Li ion becomes the bottleneck step during the whole operation of Li ion cell. The energy required to break-up Li ion salvation sheath was hence considered the activation energy barrier that a solvated Li ion must overcome in order to be intercalated. This barrier often constitutes the rate-determining step of the entire Li ion intercalation chemistry.

More recent studies established that the formation chemistry of interphase also closely depends on the Li on solvation sheath structure, which affects how difficult it is to intercalate a solvated Li ion into an intercalation-type electrode; e.g., Xu, K., et al., “Solvation Sheath of Li⁺ in Nonaqueous Electrolytes and Its Implication of Graphite/Electrolyte Interface Chemistry,” J. Phys. Chem., C, Vol. 111, Issue 20, pp. 741-7421, May 2.2007, the complete disclosure of which, in its entirety, is herein incorporated by reference. It is therefore of great interest to the battery industry to find an approach that could catalyze the breaking up of Li ion solvation sheath, so that the resistances that hinder the movement of Li ion during charge and discharge can be minimized.

Early attempts to manipulate interphase chemistry mainly involve the use of organic and non-ionic compounds at small concentrations in electrolyte. However, this approach does not aim at minimizing the energy barrier required for Li ion solvation sheath disruption. Instead, it pursues a thinner intrephase so that the naked Li ion after stripping of its solvation sheath can travel smaller distance. In general, the incorporation of those molecular additives, whose reduction or oxidation potentials are so designed that their decompositions always precede that of the main components of electrolyte, renders a thinner and therefore less resistive interphase, consequently lowers the migration resistance to a naked Li ion across the intrephase. However, the main impedance contributor, which is the break-up of Li ion solvation sheath, would remain unaffected by thinner interphase, because the energy barrier for the dissociation of Li ion-solvent molecule interaction would not depend on how thin the intrephase is. It is therefore still of great interest to the battery industry to find an approach that could directly lower the activation energy for a solvated Li ion to be intercalated.

More recent efforts discovered that, when intercalation electrodes are precoated with a thin metal layer by using sputtering method under vacuum, the resistance corresponding to that of desolvation process decreases drastically; e.g., Nobili, F., et al., Electrochemical Investigation of Polarization Phenomena and Intercalation Kinetics of Oxidized Graphite Electrodes Coated With Evaporated Metal Layers,” Journal of Power Sources, Vol. 180, Issue 2, pp. 845-851. Jun. 1, 2008, the complete disclosure of which, in its entirety, is herein incorporated by reference. It is believed that the metallic nature of the intercalation electrode surface serves as catalyst that helps lower the activation energy of Li ion desolvation. This is the first time that the energy barrier required to break up the Li ion solvation sheath was found. The resultant electrode would offer superior performance in Li ion cells under lower operating temperatures and high charge/discharge rates. However, due to the technical difficulty and hence high cost in precoating under vacuum, the approach adopted by this approach generally is not used for large-scale electrode area production, rendering it impractical for the battery industry. Furthermore, the sputtering technique generally cannot distinguish the fine structure of intercalation electrode, but would instead coat the entire exposed surface, no matter basal or edge, of the electrode in an indiscriminate manner. In other words, the inactive sites of the intercalation electrodes; i.e., the basal regions, would receive far more coverage than the key and active sites; i.e., active sites. Thus, the nature of high energy consumption and low efficiency renders this approach even further impractical. An improved approach mixes the metal powder with intercalation electrode during the electrode manufacture step, which still does not address the efficiency issue; i.e., how to precisely place metal at the active sites while avoiding the unnecessary inactive sites.

It is therefore still of significant interest to the battery industry to find an approach that could lower the activation energy for a solvated Li ion to be intercalated in a simple, economical, scalable and efficient manner, in which the active (edge) sites of the intercalation electrodes are precisely targeted while the inactive (basal) sites remain unaffected, and minimum or no additional processing step is required, and there is no limit on the area of electrode to be manufactured.

### SUMMARY

In view of the foregoing, an embodiment herein provides an electrochemical cell comprising a negative electrode (cathode) comprising an electrode active material that reversibly intercalates and de-intercalates any of cations and molecules; a positive electrode (anode) comprising an electrode active material that reversibly intercalates and de-intercalates any of cations, anions, and molecules; a separator material that separates the negative electrode from the positive electrode; and an electrolyte comprising a base electrolyte composition, an ionic compound additive, and a solvent comprising any of aqueous and non-aqueous electrolyte solvents, wherein the additive dissolves in the base electrolyte composition as well a majority of the aqueous or non-aqueous electrolyte solvents, wherein the additive comprises a solubility of at least approximately 0.01 in the base electrolyte composition, wherein the additive dissociates into corresponding cations and anions upon dissolution, and wherein the cations originate from a metal element and reduce to an elemental form at a potential that is at least approximately 0.50 V above that of lithium.

The base electrolyte composition comprises any of aqueous solvents, non-aqueous solvents, alkali or other metal salts, and other molecular or ionic additives. The additive comprises any of an alkali metal salt, alkaline earth metal salt, transition metal salt, inner-transition metal salt, other metal salt, metalloid salt, or a mixtures thereof, wherein the cations reduce on the positive electrode to an elemental form at a potential at least approximately 1.00 V above that of lithium, wherein the anions remain stable without decomposition on the negative electrode at potential up to approximately 5.0 V above that of lithium.

The base electrolyte composition comprises any of aqueous solvents, non-aqueous solvents, and solvent mixtures comprising any of (i) water, (ii) cyclic or acyclic carbonates and carboxylic esters comprising any of ethylene carbonate, propylene carbonate, vinylene carbonate, dimethyl carbonate, diethyl carbonate, ethyl methyl carbonate, γ-butyrolactone, methyl butyrate, and ethyl butyrate, (iii) cyclic or acyclic ethers comprising any of diethylether, dimethyl ethoxglycol, and tetrahydrofuran, (iv) cyclic or acyclic organic sulfones and sulfites comprising any of tetramethylene sulfone, ethylene sulfite, and ethylmethyl sulfone, (v) cyclic or acyclic nitriles comprising any of acetonitrile and ethoxypropionitrile, and (vi) derivatives and mixtures thereof.

The base electrolyte composition comprises any of a salt and salt mixture comprising any of lithium hexafluorophosphate (LiPF₆), lithium hexafluoroarsenate (LiAsF₆), lithium tetrafluoroborate (LiBF₄), lithium perfluoroalkylfluorophosphate (LiP(CₙF₂ₙ₊₁)ₓF₆₋ₓ, where 0≦n≦10, 0≦x≦6), lithium perfluoroalkylfluoroborate (LiB(CₙF₂ₙ₊₁)ₓF₄₋ₓ, where 0≦n≦10, 0≦x≦4), lithium bis(trifluoromethanesulfonyl)imide (Lilm), lithium bis(perfluoroethanesulfonyl)imide (LiBeti), lithium bis(oxalato)borate (LiBOB), lithium (difluorooxalato)borate (LiBF₂C₂O₄), and mixtures thereof.

The base electrolyte composition comprises any of a salt and salt mixture that dissolves to a concentration of at least approximately 0.2 M in the aqueous or non-aqueous solvent or solvent mixtures. The additive comprises at least one cation species comprising any of copper, silver, iron, nickel, zinc, gold, platinum, cobalt, magnesium, aluminum, boron, and manganese. The additive comprises at least one anion species that effectively passivates a surface of the negative electrode so that bulk electrolyte species or anions of the additive remain stable on the surface up to a potential of approximately 5.0 V above that of lithium.

The additive comprises at least one anion species comprising any of (PF₆⁻), tetrafluoroborate (BF₄), perchlorate (ClO₄⁻), bis(trifluoromethanesulfonyl)imide ((CF₃SO₂)₂N⁻ or Im), bis(perfluoroethanesulfonyl) ((C₂F₅SO₂)₂N⁻ or Beti), and trifluoromethanesulfonate (CF₃SO₃⁻, or Tf). The concentrations of the additive range from approximately 0.1 ppm to 10% with respect to total solvent weight. The negative electrode comprises an intercalation material comprising a lattice structure that accommodates any guest ions or molecules, and comprises any of carbonaceous materials with various degrees of graphitization, lithiated metal oxides, and chalcogenides. The positive electrode comprises an active material comprising any of transition metal oxides, metalphosphates, chalcogenides, and carbonaceous materials with various degree of graphitization. The separator material comprises any of a polyolefin separator and a gellable polymer film.

The anions remain stable at a surface of the negative electrode within an operational potential of the negative electrode. The anions decompose and effectively passivate a surface of the negative electrode so that no sustaining decomposition occurs within an operational potential of the negative electrode. The anions remain stable at a surface of the negative electrode up to a potential approximately 5.0 V above that of lithium. The anions decompose and effectively passivate the surface of the negative electrode so that no sustaining decomposition occurs up to a potential approximately 5.0 V above that of lithium. Moreover, at least one molecular compound is present as ligands to the cations.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates the initial voltage profiles of graphitic anode half cells under constant current charge-discharge, wherein the electrolytes contain ionic additives, copper tetrakis(acetonitrile) tetrafluoroborate (Cu(AN)₄BF₄), at different concentrations from 0 to 8%, as indicated in the legend according to an embodiment herein;

FIG. 2 illustrates the comparison of AC impedance spectra as measured on three selected graphitic anode half cells, wherein the electrolyte contains 0% (base electrolyte), 1% copper tetrakis(acetonitrile) tetrafluoroborate (Cu(AN)₄BF₄), and 1% AgTf, respectively according to an embodiment herein; and

FIG. 3 illustrates a schematic diagram of an electrochemical cell according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

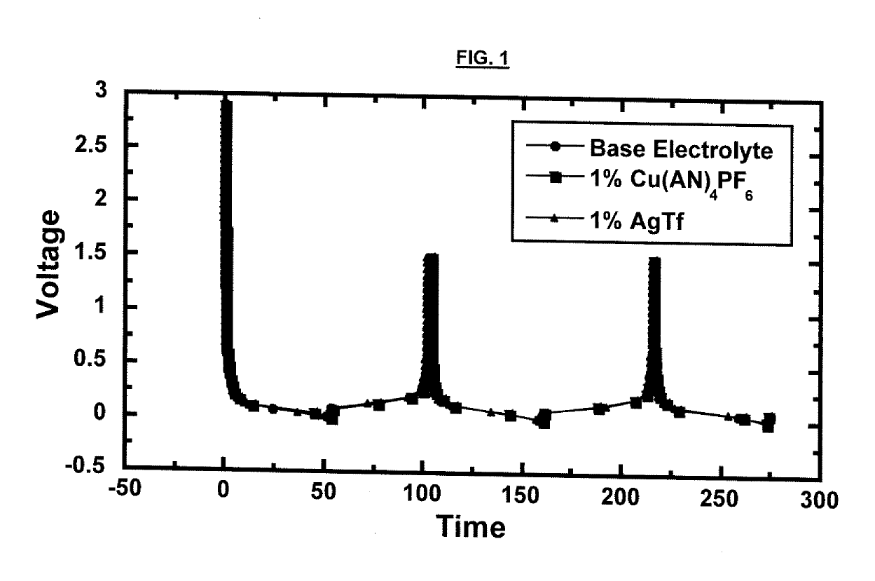

The embodiments herein provide a synthesis of a series of additives for non-aqueous electrolytes. Their presence in electrolytes designed for Li-based secondary cells or any electrochemical devices using intercalation electrodes can effectively lower the so-called “charge-transfer” resistance at the interface, and provide the device with much faster kinetics upon both charge and discharge. The additives provided by the embodiments herein offer higher performance for Li ion cells or any electrochemical devices that uses intercalation electrodes. Referring now to the drawings, and more particularly to FIGS. 1 through 3, where similar reference characters denote corresponding features consistently throughout the figures, there are shown preferred embodiments.

It is to be understood that the terminology used herein is for the purpose of describing particular embodiments only, and is not intended to be limiting. In accordance herein, “inorganic” refers to a structure that contains no hydrocarbon moieties; “organic” refers to a structure that contains hydrocarbon moieties; “ionic” refers to compounds that can be dissociated into a cation species that bears positive charge and an anion species that bears equal but negative charge in non-aqueous electrolyte solvents; “molecular” refers to compounds that cannot be dissociated into any ionic species in non-aqueous electrolyte solvents; “ligand” refers to molecular compound that can coordinate with a central ion through its intrinsic or an induced dipole moment; “solvents” refers to molecular components of the electrolyte whose concentrations are higher than 10% by weight; “additives” refers to the molecular components of the electrolyte whose concentrations are lower than 10% by weight.

According to one embodiment, new ionic additives can be dissolved in typical non-aqueous electrolyte solvent or mixture of solvents and dissociated into corresponding cations and anions. According to another embodiment, the new ionic additives can be dissolved in typical non-aqueous electrolyte solvent or mixture of solvents and have the solubility of at least 0.01% by weight. According to another embodiment, the new ionic additives comprise at least a cation that originates from an alkali metal, an alkaline earth metal, a transition metal, an inner-transition metal, or other metal or metalloid in Groups 13-16 in the Periodic Table. According to another embodiment, the new ionic additives comprise at least a cation that, when dissolved in a non-aqueous electrolyte solvent or mixture of solvents, can be reduced on negative electrode to its elemental form. According to another embodiment, the new ionic additives comprise at least a cation that, when dissolved in non-aqueous electrolyte solvent or mixture of solvents, can be reduced on negative electrode to its elemental form at a potential that is at least 0.50 V above that of Li.

The cation species can be originated from all the metals in Groups 1 through 17, with their reduction potential lays at least 0.50 V above that of Li. In another embodiment, the reduction potential of the cation species of the ionic additive is at least 1.0 V above that of Li. Additionally, the metal origins of the cation species can be selected from the following lists: copper (Cu), silver (Ag), iron (Fe), nickel (Ni), zinc (Zn), gold (Au), platinum (Pt), cobalt (Co), magnesium (Mg), aluminum (Al), manganese (Mn), et cetera. The cation species derived from these elements can be in any possible oxidation states allowed by nature. In another embodiment, the new ionic additives comprise an anion that, when dissolved in non-aqueous electrolyte solvent or mixture of solvents, can be stable without decomposition on the cathode surface up to 5.0 V vs. Li. Furthermore, in another embodiment, the anion can decompose on cathode at a lower potential but can passivate the cathode surface effectively, so that no sustaining decomposition occurs on the cathode surface up to 5.0 V vs. Li.

In another embodiment, the anion species can be selected from the following list: hexafluorophosphate (PF₆⁻), tetrafluoroborate (BF₄⁻), perchlorate (ClO₄⁻), bis(trifluoromethanesulfonyl)imide ((CF₃SO₂)₂N⁻ or Im), bis(perfluoroethanesulfonyl) ((C₂F₅SO₂)₂N⁻ or Beti), trifluoromethanesulfonate (CF₃SO₃⁻, or Tf), etc. Furthermore, the new ionic additives can also comprise one or more than one molecular components that serve as neutral ligands to the cation. Such molecular components can be selected from the following: acetonotrile, diethylether, tetrahydrofuran, ethylene carbonate, or dimethylcarbonate, etc.

Having described the general composition of the ionic compound additives of the embodiments herein, one with ordinary skill in the art can identify any possible combinations between the cations and anions that meet these requirements and generate a series of such ionic additives. The ionic compounds used by the embodiments herein as additive comprises any of transition metal salts or organometallic compounds including, but not limited to copper (I or II) tetrakis(acetonitrile) tetrafluoroborate (Cu(AN)₄BF₄ or Cu(AN)₄(BF₄)₂), copper (I or II) hexafluorophosphate (CuPF₆ and Cu(PF₆)₂), copper (I or II) trifluoromethanesulfonate (CuTf or CuTf₂), copper bis(trifluoromethanesulfonypimide (CuIm or CuIm₂), silver perchlorate (AgClO₄), silver hexafluorophosphate (AgPF₆), silver tetrafluoroborate (AgBF₄), silver (I) trifluoromethanesulfonate (AgTf), tin (I or II) hexafluorophosphate (SnPF₆ or Sn(PF₆)₂), zinc trifluoromethanesulfonate (ZnTf₂), etc.

In further aspects of the embodiments herein, the base electrolyte solutions can be prepared by using the solvents and Li salts by following known procedures that can be readily performed by one with ordinary skill in the art. In one embodiment, the electrolyte solvents comprise mixtures of organic carbonates that are either cyclic in structure such as ethylene carbonate (EC) or propylene carbonate (PC), or linear in structure such as dimethyl carbonate (DMC), diethyl carbonate (DEC) or ethylmethyl carbonate (EMC), or non-carbonate molecular compounds such acetonitrile (AN), ethyl acetate (EA), and methylbutyrate (MB), etc.

In one embodiment, the Li salt comprises any of lithium hexafluorophosphate (LiPF₆), lithium hexafluoroarsenate (LiAsF₆), lithium tetrafluoroborate (LiBF₄), lithium perfluoroalkylfluorophosphate (LiP(CₙF₂ₙ₊₁)ₓF₆₋ₓ, where 0≦n≦10, 0≦x≦6), lithium perfluoroalkylfluoroborate (LiB(CₙF₂ₙ₊₁)ₓF₆₋ₓ, where 0≦n≦10, 0≦x≦4), lithium trifluoromethanesulfonate (LiTf), lithium bis(trifluoromethanesulfonyl)imide (LiIm), and lithium bis(pentafluoroethanesulfonyl) (LiBeti), lithium bis(oxalato)borate (LiBOB), and lithium (difluorooxalato)borate (LiBF₂C₂O₄), etc.

The base electrolyte may serve both as the benchmark standard in the tests and as the basis on which the electrolyte solutions of the embodiments herein are formulated. In another embodiment, the electrolyte solutions are formulated by incorporating the ionic additives at various concentrations ranging from 0.1 ppm up to 10% in the base electrolyte solutions, by following the procedures that can be readily performed by one with ordinary skill in the art.

In another aspect of the embodiments herein, an electrochemical device is configured using the electrolyte solution formulated in accordance with the embodiments herein. These devices include, but are not limited to, (1) anode half cells with lithium metal electrode and graphitic carbon anode or transition metal oxide anode; (2) cathode half cells with lithium metal electrode and various transition metal oxide or olivine metalphosphate as cathode; (3) full Li ion cells with graphitic carbon anode or transition metal oxide anode and various transition metal oxide or olivine metalphosphate as cathode; and (4) dual intercalation cells in which both cation and anion intercalate simultaneously into lattices of anode and cathode materials, respectively. The above cells are assembled according to the procedures that can be readily performed by one with ordinary skill in the art. These electrochemical devices containing the electrolyte solutions as provided by the embodiments herein can afford improved rate capabilities and low temperature capacity utilizations.

The charge-transfer resistance at the interface between electrolytes and intercalation-type electrodes constitute a major energy barrier to the kinetics of the cell chemistry in conventional devices. Accordingly, the embodiments herein minimize this resistance by manipulating the interface chemistry so that electrochemical devices using intercalation electrodes can achieve superior performance. The additives provided by the embodiments herein can form a desired interface between electrolyte and an intercalation electrode. These interfaces can confer a desired metallic aspect to the intercalation sites on electrodes and thus offer minimal impedances during the intercalation processes. The structure of the additives provided by the embodiments herein offer tailored surface chemistry on electrodes, so that the operation of electrochemical cells can be better optimized at extreme conditions such as low temperature or high drain rate.

The following examples are given to illustrate specific applications of the embodiments herein and are not intended to limit the scope of the embodiments herein.

### Example 1

### Synthesis of Cuprous Tetrakis(Acetonitrile) Tetrafluoroborate

To a 500 mL flask a piece of copper and 50 mL dry acetonitrile is added to 2 g nitrosyl tetrafluoroborate under dry atmosphere. The reactant is occasionally placed under vacuum to help removal of nitric oxide. After 5 hours the reactant becomes green, and is then filtered through a 10-micron sintered glass filter. The obtained solution is treated with copper powder. After refluxing until the solution became colorless, the reactant is filtered again and left standing in the dry room. Upon cooling the title compound crystallizes. The overall yield is approximately 60%.

### Example 2

### Synthesis of Cuprous Tetrakis(Acetonitrile) Hexafluorophosphate

To a 500 mL flask a piece of copper and 50 mL dry acetonitrile is added to 2 g nitrosyl hexafluorophosphate under dry atmosphere at 0° C. The reactant is occasionally placed under vacuum to help removal of nitric oxide. After 5 hours the reactant becomes blue-green, and is then filtered through a 10-micron sintered glass filter. The obtained solution is treated with copper powder. After refluxing until the solution becomes colorless, the reactant is filtered again and left standing in the dry room. Upon cooling the title compound crystallizes. The overall yield is approximately 50%.

### Example 3

### Synthesis of Cu (II) Bis(trifluoromethanesulfonyl)imide

Lithium Bis(trifluoromethanesulfonyl)imide available from 3M Corp, Minnesota, USA, is dissolved in deionized water and then passed through a pre-protonized cation exchange column. The obtained acid solution is concentrated by heating and then treated again with a pre-protonized cation exchange column. Basic copper carbonate (CuCO₃.Cu(OH)₂) is then carefully added to the imidic acid solution obtained under stirring. After pH reaches 7.5-8, the reactant is concentrated until all water evaporates. The obtained crystal is subjected to repeated recrystallization in ethanol to yield the title compound. The overall yield is approximately 90%.

### Example 4

### Formulation of Novel Electrolyte Solutions

This example summarizes a general procedure for the preparation of electrolyte solutions comprising the solvents or additives, which is commercially available, or whose synthesis has been disclosed in Examples 1 through 3. Both the concentration of the lithium salts and the relative ratios between the additives can be varied according to needs. The lithium salts may comprise any of LiPF₆, LiAsF₆, LiBF₄, LiP(CₙY₂ₙ₊₁)ₓF₆₋ₓ (0≦n≦10, 0≦x≦6), LiB(CₙF₂ₙ₊₁)ₓF₄₋ₓ (0≦n≦10, 0≦x≦4), LiIm, LiBeti, LiBOB, and LiBF₂C₂O₄, and mixtures thereof. The resultant electrolyte solution may contain at least one of these solvents and one of these Li salts and one of the ionic additives that are provided according to the embodiments herein. Hence, a 1000 g base electrolyte solution of 1.0 m LiPF₆/EC/EMC (3:7) is made in a glovebox by mixing 300 g EC and 700 g EMC followed by adding 151.9 g LiPF₆. The aliquots of the base electrolyte solution is then taken to be mixed with various amount of ionic additive Cu(AN)₄PF₆ as synthesized in Example 1. The concentration of Cu(AN)₄PF₆ ranges from 0.1 ppm up to 8%.

In a similar manner, the electrolyte solution provided by the embodiments herein along with other ionic additives at varying concentrations are also made with AgClO₄, AgPF₆, AgBF₄, AgTf, SnPF₆ or Sn(PF₆)₂, ZnTf₂. etc. Table I lists some typical electrolyte solutions prepared and tested. It should be noted that the compositions provided in Table I may or may not be the optimum compositions for the electrochemical devices in which they are intended to be used, and they are not intended to limit the scope of the embodiments herein.

TABLE 1
Novel Electrolyte Solutions with Ionic Additives

| 1. Salt | | 4. Additive |
|---|---|---|
| 2. Concentration | 3. Solvent Ratio | Concentration |
| (m) | (by Weight) | 5. (by Weight) |
| 6. LiPF₆ (1.0) | 7. EC/EMC (30:70) | 8. None |
| 9. LiBF₄ (1.0) | 10. EC/EMC (30:70) | 11. Cu(AN)₄BF₄ (1%) |
| 12. LiPF₆ (1.0) | 13. EC/EMC (30:70) | 14. Cu(AN)₄PF₆ (1%) |
| 15. LiPF₆ (1.0) | 16. EC/EMC (30:70) | 17. Cu(AN)₄PF₆ (0.8%) |
| 18. LiPF₆ (1.0) | 19. EC/EMC (30:70) | 20. AgTf (1%) |
| 21. LiBF₄ (1.0) | 22. EC/EMC (30:70) | 23. AgTf (10 ppm) |
| 24. LiPF₆ (1.0) | 25. EC/EMC (30:70) | 26. ZnTf (1%) |
| 27. LiPF₆ (1.0) | 28. EC/EMC (30:70) | 29. CuIm₂ (1%) |
| 30. LiPF₆ (1.0) | 31. EC/EMC (30:70) | 32. AgIm (0.5%) |
| 33. LiPF₆ (1.0) | 34. EC/EMC (30:70) | 35. ZnIm₂ (1%) |
| 36. LiPF₆ (1.0) | 37. EC/EMC (30:70) | 38. AgPF₆ (1%) |
| 39. LiPF₆ (1.0) | 40. EC/EMC (30:70) | 41. AgBF₄ (1%) |

### Example 5

### Fabrication of a Lithium Ion Cell

This example summarizes the general procedure of the assembly of a lithium ion cell. Typically, a piece of Celgard polypropylene separator is sandwiched between an anode composite film that is based on graphitic carbon or a transition metal oxide such as spinel structured titanium oxide, and a cathode composite film that is based on either lithiated transition metal oxides, lithiated metalphosphate or mixture thereof. The lithium ion cell is then activated by soaking the separator with the electrolyte solutions as prepared in Example 4, and sealed with appropriate means. Upon the initial charge, the ionic compound additives deposit nanosized metal regions on the edge regions of the anode lattice structures and form an interphase of low resistance. During the subsequent operation, the Li ions intercalate into both cathode and anode lattice structures.

### Example 6

### Fabrication of a Dual Ion Intercalation Cell

This example summarizes the general procedure of the assembly of dual ion intercalation cells. Typically, a piece of Celgard polypropylene separator is sandwiched between an anode composite film that is based on an intercalation electrode, and a cathode composite film that is also based on an intercalation electrode that might be the same with or different from the anode. The dual ion intercalation cell is then activated by soaking the separator with the electrolyte solutions as prepared in Example 4, and sealed with appropriate means. Upon the initial charge, the ionic compound additives deposit nanosized metal regions on the edge regions of the anode lattice structures and form an interphase of low resistance. During the charge of a dual intercalation cell, the anions of the electrolyte intercalate into cathode structure, while cations of the electrolyte intercalate into anode structure.

### Example 7

### Fabrication of an Electrochemical Capacitor

This example summarizes the general procedure of the assembly of electrochemical double layer capacitors. A piece of Celgard polypropylene separator is sandwiched between a pair of composite electrodes based on activated carbon materials and coated on various metal current collectors. The separator is then activated with the electrolyte solutions as prepared in Example 11, and sealed with appropriate means.

Upon the initial charge, the ionic compound additives deposit nanosized metal regions on the edge regions of the anode lattice structures and form an interphase of metallic nature. This interphase accelerates the release of accumulated charges at a faster kinetics.

### Example 8

### Testing of the Electrochemical Cells

This example summarizes the general procedure of testing the electrochemical devices assembled in Examples 5 through 7. The half cells of lithium ion anode and cathode are subjected to both voltammetric and galvanostatic cyclings, and the full lithium ion cells, dual intercalation cells, and electrochemical double layer capacitors are subjected to galvanostatic cyclings followed by potentiostatic floating. Standard potentiostat/galvanostat and battery testers are employed. Electrochemical impedance spectrum is measured by maintaining a stable potential difference between the tested electrode and a reference electrode, while generating a sinusoidal AC pulse with the amplitude of 0.5 mV.

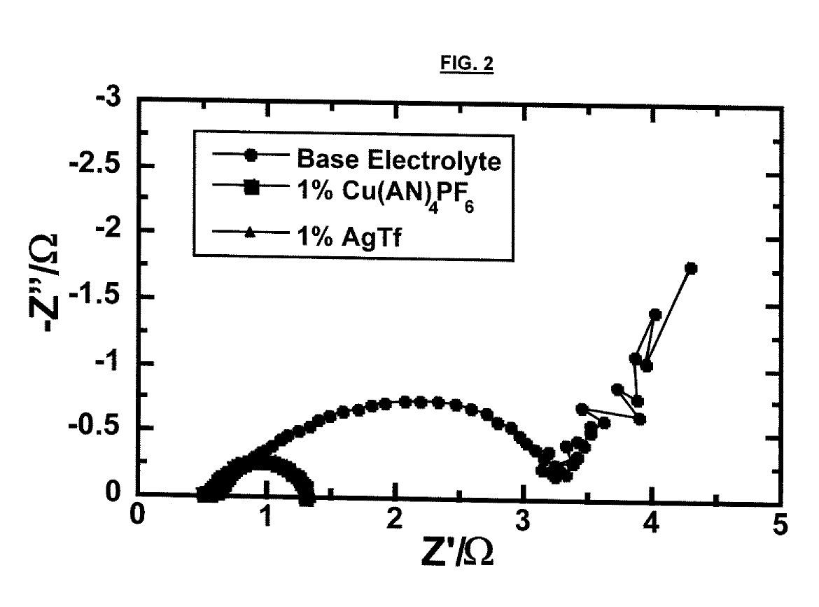

As an example for the purpose of illustration, the galvanostic cycling results of anode half cells in two selected electrolytes is shown in FIG. 1, and the Nyquist plots for the AC impedances of these electrolytes is shown in FIG. 2.

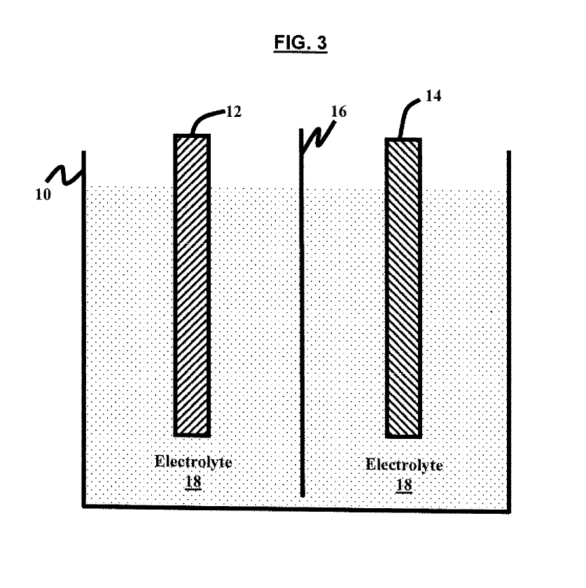

FIG. 3 illustrates an example of an electrochemical cell 10 in accordance with the embodiments herein. The configuration of the electrochemical cell 10 shown in FIG. 3 is merely for illustrative purposes, and the embodiments herein are not restricted to any particular configuration, geometry, or type of electrochemical cell configuration. As shown in the example of FIG. 3, the electrochemical cell 10 comprises a negative electrode (cathode) 12 comprising an electrode active material that reversibly intercalates and de-intercalates any of cations and molecules; a positive electrode (anode) 14 comprising an electrode active material that reversibly intercalates and de-intercalates any of cations, anions, and molecules; a separator material 16 that separates the negative electrode 12 from the positive electrode 14; and an electrolyte 18 comprising a base electrolyte composition, an ionic compound additive, and a solvent comprising any of aqueous and non-aqueous electrolyte solvents, wherein the additive dissolves in the base electrolyte composition as well a majority of the aqueous or non-aqueous electrolyte solvents, wherein the additive comprises a solubility of at least approximately 0.01 in the base electrolyte composition, wherein the additive dissociates into corresponding cations and anions upon dissolution, and wherein the cations originate from a metal element and reduce to an elemental form at a potential that is at least approximately 0.50 V above that of lithium.

The base electrolyte composition may comprise any of aqueous solvents, non-aqueous solvents, alkali or other metal salts, and other molecular or ionic additives. The additive may comprise any of an alkali metal salt, alkaline Earth metal salt, transition metal salt, inner-transition metal salt, other metal salt, metalloid salt, or a mixtures thereof, wherein the cations reduce on the positive electrode 14 to an elemental form at a potential at least approximately 1.00 V above that of lithium, wherein the anions remain stable without decomposition on the negative electrode 12 at potential up to approximately 5.0 V above that of lithium.

The base electrolyte composition may comprise any of aqueous solvents, non-aqueous solvents, and solvent mixtures comprising any of (i) water, (ii) cyclic or acyclic carbonates and carboxylic esters comprising any of ethylene carbonate, propylene carbonate, vinylene carbonate, dimethyl carbonate, diethyl carbonate, ethyl methyl carbonate, γ-butyrolactone, methyl butyrate, and ethyl butyrate, (iii) cyclic or acyclic ethers comprising any of diethylether, dimethyl ethoxglycol, and tetrahydrofuran, (iv) cyclic or acyclic organic sulfones and sulfites comprising any of tetramethylene sulfone, ethylene sulfite, and ethylmethyl sulfone, (v) cyclic or acyclic nitriles comprising any of acetonitrile and ethoxypropionitrile, and (vi) derivatives and mixtures thereof.

The base electrolyte composition may comprise any of a salt and salt mixture comprising any of lithium hexafluorophosphate (LiPF₆), lithium hexafluoroarsenate (LiAsF₆), lithium tetrafluoroborate (LiBF₄), lithium perfluoroalkylfluorophosphate (LiB(CₙF₂ₙ₊₁)ₓF₆₋ₓ, where 0≦n≦10, 0≦x≦6), lithium perfluoroalkylfluoroborate (LiB(CₙF₂ₙ₊₁)ₓF₄₋ₓ, where 0≦n≦10, 0≦x≦4), lithium bis(trifluoromethanesulfonypimide (LiIm), lithium bis(perfluoroethanesulfonyl)imide (LiBeti), lithium bis(oxalato)borate (LiBOB), lithium (difluorooxalato)borate (LiBF₂C₂O₄), and mixtures thereof.

The base electrolyte composition may comprise any of a salt and salt mixture that dissolve to a concentration of at least approximately 0.2 m in the aqueous or non-aqueous solvent or solvent mixtures. The additive may comprise at least one cation species comprising any of copper, silver, iron, nickel, zinc, gold, platinum, cobalt, magnesium, aluminum, boron, and manganese. The additive may comprise at least one anion species that effectively passivates a surface of the negative electrode 12 so that bulk electrolyte species or anions of the additive remain stable on the surface up to a potential of approximately 5.0 V above that of lithium.

The additive may comprise at least one anion species comprising any of hexafluorophosphate (PF₆⁻), tetrafluoroborate (BF₄⁻), perchlorate (ClO₄), bis(trifluoromethanesulfonyl)imide ((CF₃SO₂)₂N⁻ or Im), bis(perfluoroethanesulfonyl) ((C₂F₅SO₂)₂N⁻ or Beti), and trifluoromethanesulfonate (CF₃SO₃⁻, or TO. The concentrations of the additive may range from approximately 0.1 ppm to 10% with respect to total solvent weight. The negative electrode 12 may comprise an intercalation material comprising a lattice structure that accommodates any guest ions or molecules, and comprises any of carbonaceous materials with various degrees of graphitization, lithiated metal oxides, and chalcogenides. The positive electrode 14 may comprise an active material comprising any of transition metal oxides, metalphosphates, chalcogenides, and carbonaceous materials with various degree of graphitization. The separator material may comprise any of a polyolefin separator and a gellable polymer film.

The anions may remain stable at a surface of the negative electrode 12 within an operational potential of the negative electrode 12. The anions may decompose and effectively passivate a surface of the negative electrode 12 so that no sustaining decomposition occurs within an operational potential of the negative electrode 12. The anions may remain stable at a surface of the negative electrode 12 up to a potential approximately 5.0 V above that of lithium. The anions may decompose and effectively passivate the surface of the negative electrode 12 so that no sustaining decomposition occurs up to a potential approximately 5.0 V above that of lithium. Moreover, at least one molecular compound may be present as ligands to the cations.

The embodiments herein provide a series of ionic compounds that can be used as additives in non-aqueous electrolytes and in electrochemical devices. These ionic compounds are so chosen that their reductive decomposition potentials locate above approximately 0.5-1.0 V above that of Li. Therefore, upon initial cell formation, metal particle deposits are deposited at the edge regions of the intercalation sites before a solid electrolyte interface (SET) is formed by organic solvent decomposition. The presence of the nanoscale metal particles confers a desired metallic nature to the carbonaceous electrodes and drastically reduces the desolvation energy barrier of ions at the interphase. Such tailored interphases offer low charge-transfer resistance that result in fast cell chemistry. Benefited from these tailored interphases is the performance of those electrochemical devices at either low temperatures or high drain rates.

In addition to Li ion batteries where these ionic additives can be a catalyst to break up the solvation sheath of Li ion, these additives are also useful in any other electrochemical devices that use intercalation-type electrodes. The increase in the metallic nature at the edge sites accelerates the Faradaic processes occurring at the interphase between electrolyte and electrodes. Some applications using the embodiments described herein may include, but are not limited to, intercalation type energy storage devices such as Li ion batteries, in addition to electrochemical double layer capacitors (supercapacitors), ultracapacitors, electrolytic cells and electroplating cells used in the electroplating industry.

The ionic additives provided by the embodiments herein provide a highly effective way to reduce the interphasial resistance that often plague traditional Li ion devices or any other electrochemical devices that employ an intercalation type electrode. The presence of these ionic additives, whose reduction potential are designed to be at least approximately 0.5 V above that of Li deposition, forms a desirable metallic interphase, which catalyzes the desolvation process of Li ion. The electrochemical cell 10 incorporating these ionic additives have interfacial resistances lower than approximately one-third of the conventional electrolyte/electrode systems, thus rendering superior performance under high power applications such as high drain rate or operating at sub-ambient temperatures.

Generally, the embodiments herein provide a series of inorganic compounds that can be used as additives in non-aqueous electrolytes and in electrochemical devices (such as electrochemical cell 10). The decomposition potentials of these compounds are configured to locate above approximately 0.5-1.0 V above that of Li, so that nanosized metal particles can be deposited at the edge regions of the intercalation electrodes before organic solvent decomposition occurs. The presence of these nano-metal particles confers a metallic nature to the carbonaceous electrodes. Such tailored interface offers low “charge-transfer” resistance that result in fast cell chemistry, which benefits the device performance at either low temperatures or high drain rates. These additives are also useful in any other electrochemical devices that use intercalation-type electrodes, such as carbonaceous anodes or metal oxide-based spinel anodes.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An electrochemical cell comprising:
a negative electrode comprising an electrode active material that reversibly intercalates and de-intercalates any of cations and molecules;
a positive electrode comprising an electrode active material that reversibly intercalates and de-intercalates any of cations, anions, and molecules;
a separator material that separates said negative electrode from said positive electrode; and
an electrolyte comprising a base electrolyte composition, an ionic compound additive, and a solvent comprising any of aqueous and non-aqueous electrolyte solvents,
wherein said additive dissolves in said base electrolyte composition as well a majority of the aqueous or non-aqueous electrolyte solvents,
wherein said additive comprises a solubility of at least approximately 0.01 in said base electrolyte composition,
wherein said additive dissociates into corresponding cations and anions upon dissolution, and
wherein said cations originate from a metal element and reduce to an elemental form at a potential that is at least approximately 0.50 V above that of lithium.

2. The electrochemical cell of claim 1, wherein said base electrolyte composition comprises any of aqueous solvents, non-aqueous solvents, alkali or other metal salts, and other molecular or ionic additives.

3. The electrochemical cell of claim 1, wherein said additive comprises any of an alkali metal salt, alkaline Earth metal salt, transition metal salt, inner-transition metal salt, other metal salt, metalloid salt, or a mixtures thereof, wherein said cations reduce on said positive electrode to an elemental form at a potential at least approximately 1.00 V above that of lithium, wherein said anions remain stable without decomposition on said negative electrode at potential up to approximately 5.0 V above that of lithium.

4. The electrochemical cell of claim 1, wherein said base electrolyte composition comprises any of aqueous solvents, non-aqueous solvents, and solvent mixtures comprising any of (i) water, (ii) cyclic or acyclic carbonates and carboxylic esters comprising any of ethylene carbonate, propylene carbonate, vinylene carbonate, dimethyl carbonate, diethyl carbonate, ethyl methyl carbonate, γ-butyrolactone, methyl butyrate, and ethyl butyrate, (iii) cyclic or acyclic ethers comprising any of diethylether, dimethyl ethoxglycol, and tetrahydrofuran, (iv) cyclic or acyclic organic sulfones and sulfites comprising any of tetramethylene sulfone, ethylene sulfite, and ethylmethyl sulfone, (v) cyclic or acyclic nitriles comprising any of acetonitrile and ethoxypropionitrile, and (vi) derivatives and mixtures thereof.

5. The electrochemical cell of claim 1, wherein said base electrolyte composition comprises any of a salt and salt mixture comprising any of lithium hexafluorophosphate (LiPF₆), lithium hexafluoroarsenate (LiAsF₆), lithium tetrafluoroborate (LiBF₄), lithium perfluoroalkylfluorophosphate (LiP(CₙF₂ₙ₊₁)ₓF₆₋ₓ, where 0≦n≦10, 0≦x≦6), lithium perfluoroalkylfluoroborate (LiB(CₙF₂ₙ₊₁)ₓF₄₋ₓ, where 0≦n≦10, 0≦x≦4), lithium bis(trifluoromethanesulfonyl)imide (LiIm), lithium bis(perfluoroethanesulfonyl)imide (LiBeti), lithium bis(oxalato)borate (LiBOB), lithium (difluorooxalato)borate (LiBF₂C₂O₄), and mixtures thereof.

6. The electrochemical cell of claim 1, wherein said base electrolyte composition comprises any of a salt and salt mixture that dissolve to a concentration of at least approximately 0.2 m in the aqueous or non-aqueous solvent or solvent mixtures.

7. The electrochemical cell of claim 3, wherein said additive comprises at least one cation species comprising any of copper, silver, iron, nickel, zinc, gold, platinum, cobalt, magnesium, aluminum, boron, and manganese.

8. The electrochemical cell of claim 3. said additive comprises at least one anion species that effectively passivates a surface of said negative electrode so that bulk electrolyte species or anions of said additive remain stable on said surface up to a potential of approximately 5.0 V above that of lithium.

9. The electrochemical cell of claim 3, wherein said additive comprises at least one anion species comprising any of hexafluorophosphate (PF₆⁻), tetrafluoroborate (BF₄⁻), perchlorate (ClO₄⁻), bis(trifluoromethanesulfonyl)imide ((CF₃SO₂)₂N⁻ or Im), bis(perfluoroethanesulfonyl) ((C₂F₅SO₂)₂N⁻ or Beti), and trifluoromethanesulfonate (CF₃SO₃⁻, or Tf).

10. The electrochemical cell of claim 1, wherein concentrations of said additive ranges from approximately 0.1 ppm to 10% with respect to total solvent weight.

11. The electrochemical cell of claim 1, wherein said negative electrode comprises an intercalation material comprising a lattice structure that accommodates any guest ions or molecules, and comprises any of carbonaceous materials with various degrees of graphitization, lithiated metal oxides, and chalcogenides.

12. The electrochemical cell of claim 1, wherein said positive electrode comprises an active material comprising any of transition metal oxides, metalphosphates, chalcogenides, and carbonaceous materials with various degree of graphitization.

13. The electrochemical cell of claim 1, wherein said separator material comprises any of a polyolefin separator and a gellable polymer film.

14. The electrochemical cell of claim 1, wherein said anions remain stable at a surface of said negative electrode within an operational potential of said negative electrode.

15. The electrochemical cell of claim 1, wherein said anions decompose and effectively passivate a surface of said negative electrode so that no sustaining decomposition occurs within an operational potential of said negative electrode.

16. The electrochemical cell of claim 1, wherein said anions remain stable at a surface of said negative electrode up to a potential approximately 5.0 V above that of lithium.

17. The electrochemical cell of claim 1, wherein said anions decompose and effectively passivate said surface of said negative electrode so that no sustaining decomposition occurs up to a potential approximately 5.0 V above that of lithium.

18. The electrochemical cell of claim 1, wherein at least one molecular compound is present as ligands to said cations.

19. An electrochemical cell comprising:
a cathode comprising an electrode active material that reversibly intercalates and de-intercalates any of cations and molecules;
an anode comprising an electrode active material that reversibly intercalates and de-intercalates any of cations, anions, and molecules;
a separator material comprising any of a polyolefin separator and a gellable polymer film that separates said cathode from said anode; and
an electrolyte comprising a base electrolyte composition, an ionic compound additive, and a solvent comprising any of aqueous and non-aqueous electrolyte solvents,
wherein said additive dissolves in said base electrolyte composition as well a majority of the aqueous or non-aqueous electrolyte solvents,
wherein said additive comprises a solubility of at least approximately 0.01 in said base electrolyte composition,
wherein said additive dissociates into corresponding cations and anions upon dissolution,
wherein said cations originate from a metal element and reduce to an elemental form at a potential that is at least approximately 0.50 V above that of lithium,
wherein said base electrolyte composition comprises any of aqueous solvents, non-aqueous solvents, alkali or other metal salts, and other molecular or ionic additives, and
wherein said additive comprises any of an alkali metal salt, alkaline Earth metal salt, transition metal salt, inner-transition metal salt, other metal salt, metalloid salt, or a mixtures thereof, wherein said cations reduce on said anode to an elemental form at a potential at least approximately 1.00 V above that of lithium, wherein said anions remain stable without decomposition on said cathode at potential up to approximately 5.0 V above that of lithium.

20. The electrochemical cell of claim 19, wherein said anions remain stable at a surface of said cathode within an operational potential of said cathode.

21. The electrochemical cell of claim 19, wherein said anions decompose and effectively passivate a surface of said cathode so that no sustaining decomposition occurs within an operational potential of said cathode.

22. The electrochemical cell of claim 19, wherein said anions remain stable at a surface of said cathode up to a potential approximately 5.0 V above that of lithium.

23. The electrochemical cell of claim 19, wherein said anions decompose and effectively passivate said surface of said cathode so that no sustaining decomposition occurs up to a potential approximately 5.0 V above that of lithium.
